(19) United States
(12) Patent Application Publication
(10) Pub. No.: US 2026/0339439 A1
(43) Pub. Date: Oct. 29, 2026

(54) INTELLIGENT SOMATOSENSORY FOOT-FEEDBACK DEVICE AND USE METHOD THEREOF

(71) Applicants: JINWEI ZHANG, Guangzhou (CN); MENGTING ZHANG, Macau (CN)

(72) Inventors: JINWEI ZHANG, Guangzhou (CN); MENGTING ZHANG, Macau (CN)

(21) Appl. No.: 19/316,394

(22) Filed: Sep. 2, 2025

(30) Foreign Application Priority Data
Apr. 28, 2025 (CN) 202510547614.X

(51) Int. Cl. G06F 3/01; A63F 13/211; A63F 13/212; A63F 13/285; A63F 13/812

(52) U.S. Cl. CPC G06F 3/016; A63F 13/211; A63F 13/212; A63F 13/285; A63F 13/812

(57) ABSTRACT

An intelligent device and use method for simulating sensory vibration feedback in somatosensory foot games (such as VR, AR or MR games) are provided. The device includes a feedback part and a power supply part. The feedback part and the power supply part are electrically connected to achieve signal transmission and energy supply. The feedback part includes a fitting component and a driving component. The power supply part includes a battery module, a second limit structure, and a second elastic band. This application utilizes a separate design, allowing the device to capture game collision events in real-time through a controller of an integrated inertial measurement unit and generate high-intensity tactile feedback by combining physics engine data, optimizing the wearing experience and enhancing user immersion. This device provides a low-cost and highly reliable solution, suitable for sports games in VR, AR, or MR scenarios, significantly enhancing the user experience.

### CROSS-REFERENCE TO RELATED APPLICATIONS

This application claims priority to Chinese Patent Application No. 202510547614.X, filed on Apr. 28, 2025, which is hereby incorporated by reference in its entirety.

### TECHNICAL FIELD

The present disclosure relates to the field of game interactive devices technologies, and in particular, to a smart device and use method for simulating sensory vibration feedback in somatosensory foot games (such as VR, AR, or MR games).

### BACKGROUND

Sensory gaming devices are important interactive tools in modern interactive entertainment, widely used in scenarios such as virtual reality (VR), augmented reality (AR), or mixed reality (MR). With the increasing demand for immersive experiences among players, precise tactile feedback targeting specific body parts such as the feet has gradually become a research hotspot. However, there are still shortcomings in the design of existing motion sensing gaming devices in terms of foot feedback, especially in terms of real-time capture of in-game collision events and the generation of corresponding tactile and force feedback based on physics engine data.

After searching, a shoe with a sensory interactive device in CN212757193U was disclosed on Mar. 19, 2021. This disclosure achieves tactile feedback of user foot movements by installing vibration units on the sole of the shoe. However, in this technical solution, the vibration unit is only located on the footrest and cannot truly simulate the tactile sensation when the instep collides with the ball during football. Besides that, the device lacks real-time acquisition capability of body dynamic data, which makes it difficult to accurately capture the user's motion state and deeply interact with the game, thus limiting its application effect in football and sports games.

The above issues indicate that the existing motion sensing gaming devices have insufficient capabilities in foot feedback, especially in capturing real-time collision events in the game and generating high-intensity tactile feedback by combining physics engine data.

### SUMMARY

The purpose of the present disclosure is to provide an intelligent somatosensory foot-feedback device and a use method thereof, which solves shortcomings of the existing technology in real-time capturing collision events in games and generating corresponding intensity tactile feedback by combining high-speed vibration units, independent power modules, and wireless communication technology. At the same time, it optimizes the wearing experience and meets the demand for efficient immersive interaction in sports games such as somatosensory football.

The objective of the present disclosure is achieved through the following technical solution: an intelligent somatosensory foot-feedback device, including a feedback part and a power supply part, where the feedback part and the power supply part are electrically connected to achieve signal transmission and energy supply; the feedback part is configured to be worn on a user's foot, and includes a fitting component and a driving component; the power supply part is configured to be fixed on a thigh, and includes a battery module, second limit structures, and a second elastic band; the battery module includes a second housing, a battery pack, a first signal transmission module, and a control circuit; the battery pack, the first signal transmission module, and the control circuit are provided inside the second housing; the first signal transmission module and the control circuit are electrically connected; a surface of the second housing is provided with a plurality of second limit structures, and the second elastic band is provided between two of the plurality of second limit structures.

In some embodiments of the present disclosure, the fitting component includes a contact piece, an outer surface of the contact piece is provided with a plurality of first limit structures, and a first elastic band is provided between two of the plurality of first limit structures, a locking buckle is provided on the first elastic band; the driving component includes a first housing provided on an outer surface of the contact piece, where the first housing is provided with a sealing cover through a plurality of fasteners to form a water-resistant and dust-proof structure; the driving component further includes a vibration motor provided inside the first housing, and the vibration motor is electrically connected to the control circuit; a vibration block is fixedly provided on an output shaft of the vibration motor; the first housing further includes a backup power supply, a controller of an integrated inertial measurement unit, and a second signal transmission module; the first signal transmission module is electrically connected to the second signal transmission module, the controller of the integrated inertial measurement unit is connected to the second signal transmission module, and the controller of the integrated inertial measurement unit is electrically connected to the control circuit so as to trigger the vibration motor based on physics engine data in a game, and the battery pack is electrically connected to the backup power source.

In some embodiments of the present disclosure, an operating component is provided on an outer side of the second housing, and the operating component is electrically connected to the control circuit; the outer side of the second housing is further provided with a plurality of indicator lights, and the indicator lights are electrically connected to the control circuit.

In some embodiments of the present disclosure, the indicator lights include at least one low battery alarm light and one wireless connection state light.

In some embodiments of the present disclosure, the contact piece is made of soft material and has a smooth inner surface; the first elastic band and the locking buckle are configured to adjust an elasticity of the contact piece to adapt to different users'foot.

In some embodiments of the present disclosure, an inner side of the second elastic band is provided with anti-slip patterns.

In some embodiments of the present disclosure, the vibration motor is located directly above an instep, and is configured to generate tactile feedback in response to physical engine data.

In some embodiments of the present disclosure, a plurality of ventilation holes are provided on two sides of the second housing, and an interface is provided at a bottom of the second housing, the interface is configured for charging or data transmission.

In some embodiments of the present disclosure, the vibration block is an irregular geometric shape, a surface of the vibration block is polished, and a weight of the vibration block is accurately calculated.

In some embodiments of the present disclosure, a use method of the intelligent somatosensory foot-feedback device, includes the following steps:
S1: providing the power supply part on a thigh and fixing the power supply part with the second elastic band and second limit structures;
S2: providing the feedback part to a foot, fixing the feedback part with a first elastic band and a locking buckle, and an inner surface of contact piece abutting against a user's foot skin;
S3: starting a device by an operating component, and establishing a wireless connection with an external gaming system;
S4: triggering a vibration motor based on an expected movement trajectory and physics engine data in a game, by the control circuit, causing the vibration motor to rotate and drive the vibration block to vibrate, and causing a contact piece to vibrate.

The present disclosure has the following beneficial effects: by separating the feedback part from the power supply part, it solves the problem that existing devices cannot meet the real-time capture of in-game collision events and generate corresponding intensity tactile feedback by combining physics engine data. The vibration motor generates vibration by driving the vibration block to rotate, and directly transmits the vibration signal to the foot through contact with the contact piece, thereby simulating tactile feedback in game scenes. The controller of the integrated inertial measurement unit can generate high-intensity tactile feedback signals based on the game scene by collecting foot motion data and linking it with an external gaming system. Through independent design in the power supply part, inconvenience caused by cable connections has been avoided, improving the portability and user experience of the device. Besides that, through the design of first and second elastic bands, the device can adapt to feet and thighs of different sizes, ensuring stable and comfortable fixation, rendering the device easy and stable to wear, thereby enhancing the user's operating experience and immersion sense.

The present disclosure solves the problem of insufficient performance of foot feedback devices in real-time capturing in-game collision events and generating high-intensity tactile feedback by combining physics engine data through the combination of the specific structure and technical means mentioned above, thereby providing the users with a low-cost and high reliability intelligent tactile foot-feedback device.

It should be noted that the above general description and the following specific implementation modes are both for the purpose of example and illustration and may not necessarily limit the present disclosure. The accompanying drawings incorporated and forming a part of the specification illustrate the subject matter of the present disclosure. At the same time, this specification and accompanying drawings are used to explain the principles disclosed herein.

### BRIEF DESCRIPTION OF DRAWINGS

In order to provide a clearer explanation of the specific implementation modes or technical solutions in the present disclosure or existing technology, a brief introduction will be given below to the accompanying drawings required for the specific implementation modes or existing technology description. It is obvious that the accompanying drawings in the following description are some of the implementation modes of the present disclosure. For those skilled in the art, other drawings can be obtained based on these drawings without creative work. The illustrative embodiments and their explanations of this application are used to explain the present application and do not constitute undue limitations on the present application.

FIG. 1 is a schematic diagram of a three-dimensional structure of a feedback part and a power supply part of the present disclosure.

FIG. 2 is a schematic diagram of the three-dimensional structure of the present disclosure.

FIG. 3 is a schematic diagram of a split three-dimensional structure of the feedback part of the present disclosure.

FIG. 4 is a schematic diagram of a partial three-dimensional structure of a driving component of the present disclosure.

FIG. 5 is a schematic diagram of the three-dimensional structure of the power supply part of the present disclosure.

Numeral reference: A—feedback part; B—power supply part; 1—contact piece; 2—first limit structure; 3—first elastic band; 4—locking buckle; 5—first housing; 6—sealing cover; 7—fastener; 8—vibration motor; 9—vibration block; 10—backup power source; 11—controller of integrated inertial measurement unit; 12—battery module; 13—second limit structure; 14—second elastic band; 15—operating component; 16—indicator light; 17—ventilation holes; 18—interface.

### DESCRIPTION OF EMBODIMENTS

In order to make the technical solutions and advantages in the embodiments of the present application clearer and more understandable, the following provides further detailed explanations of the exemplary embodiments of the present application in combination with the accompanying drawings. Obviously, the embodiments described are only a part of the present application and not an exhaustive list of all embodiments. It should be noted that the embodiments and features in the embodiments of the present application can be combined with each other without conflict.

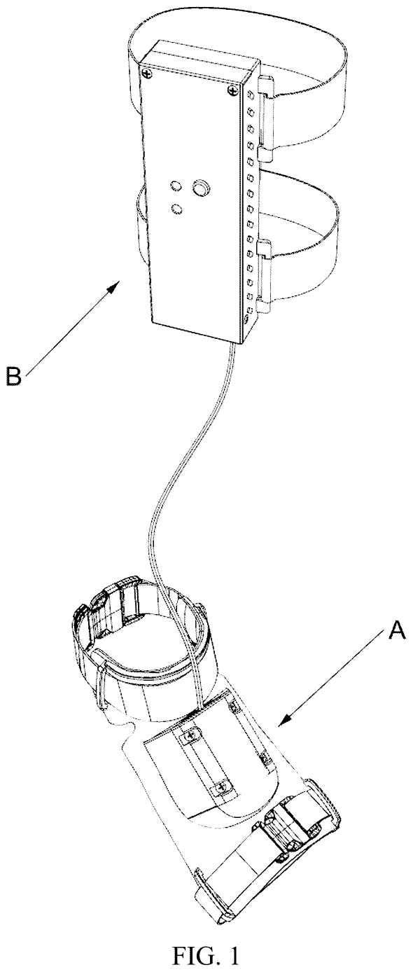

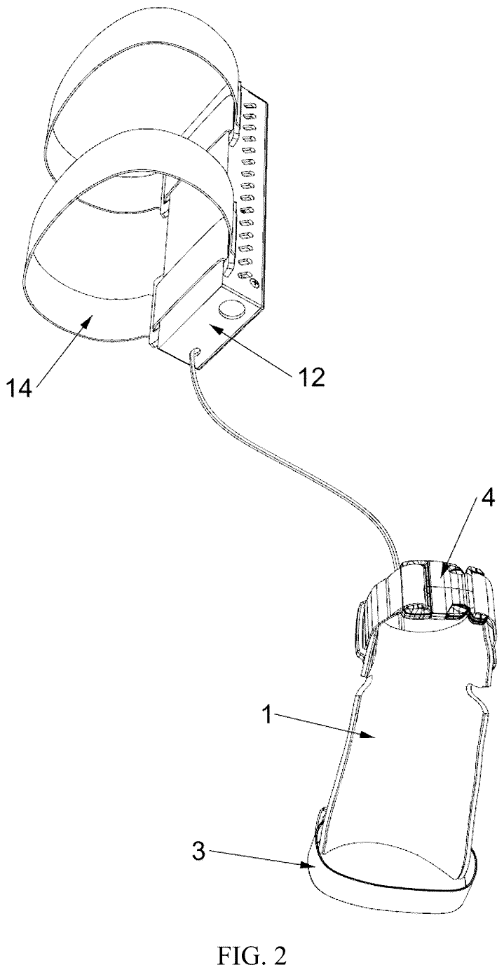

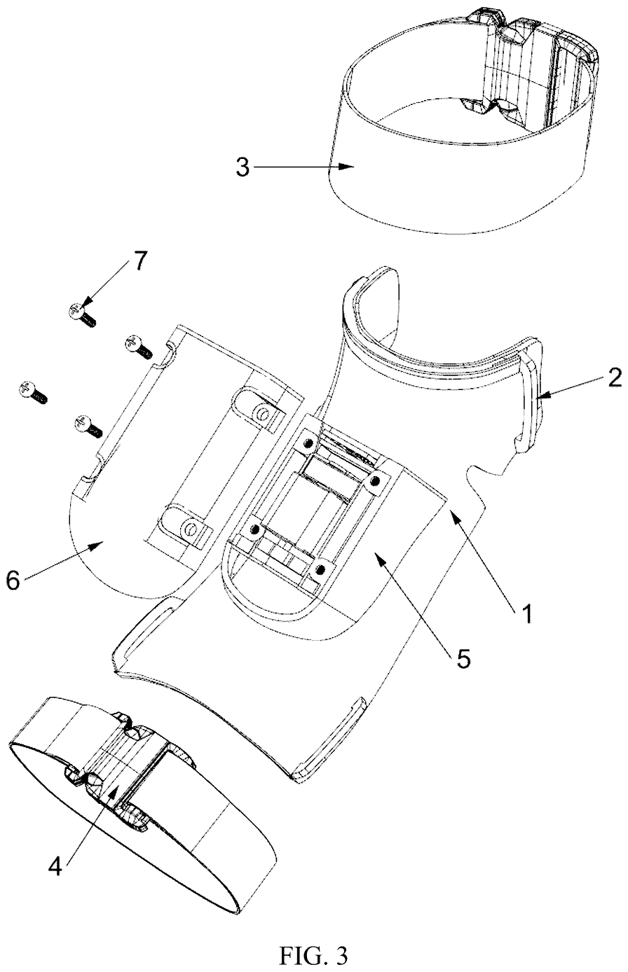

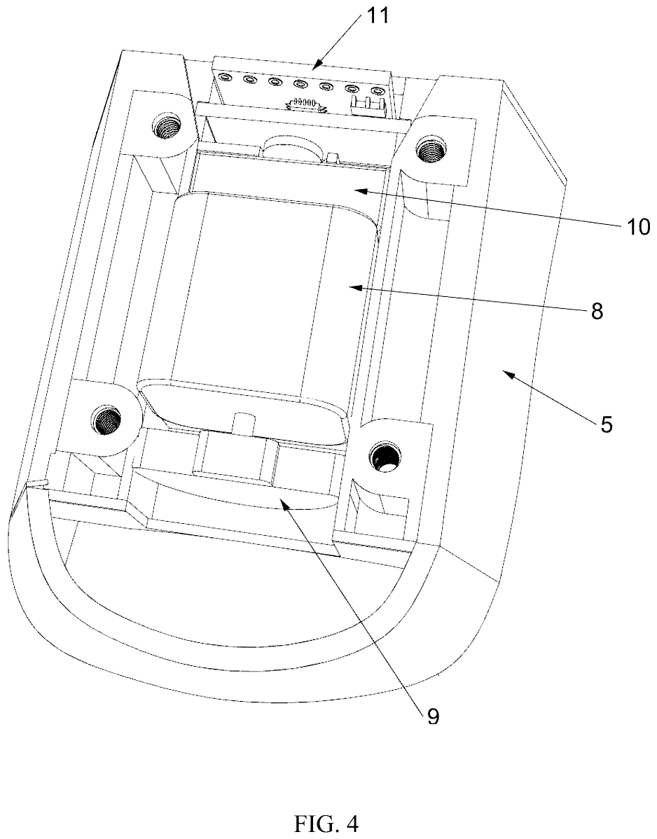

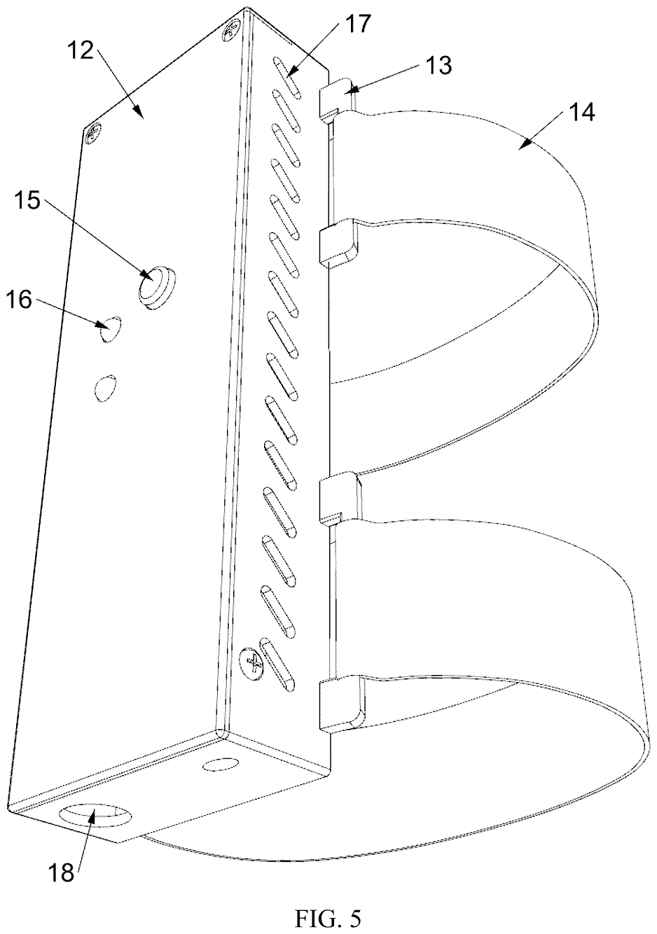

The present disclosure provides an intelligent somatosensory foot-feedback device, and its structure and use method are shown in detail in FIGS. 1 to 5. The specific embodiments of the present disclosure will be described below in combination with the accompanying drawings. FIGS. 1 and 2 show an overall structure of the intelligent somatosensory foot-feedback device, which mainly includes a feedback part A and a power supply part B. The two are connected through flexible wires or wireless connections to achieve signal transmission and energy supply. The feedback part A is worn on a user's feet and includes a fitting component and a driving component. The power supply part B is fixed on a thigh. The separate design of feedback part A and power supply part B ensures the stability and reliability of the device during long-term use. FIGS. 3 and 4 show structures of feedback part A, including the specific positions of the fitting component and the driving component. FIG. 5 shows the structure of the power supply part B, which includes a battery module 12, second limit structures 13, a second elastic band 14, an operating component 15, and specific positions of indicator lights 16. The battery module 12 includes a second housing, a battery pack, a first signal transmission module, and a control circuit.

In an implementation mode, FIG. 3 is a schematic diagram of a decomposed structure of the feedback part A, focusing on the layout and installation of a contact piece 1, first limit structures 2, a first elastic band 3, a locking buckle 4, and a first housing 5. FIG. 4 is a partial enlarged view of a vibration motor 8, a vibration block 9, a backup power supply 10, a controller 11 of an integrated inertial measurement unit, and a second signal transmission module.

The feedback part A includes the fitting component and the driving component, where the fitting component consists of the contact piece 1, the first elastic band 3, the locking buckle 4, the first housing 5, and a sealing cover 6. The contact piece 1 is made of flexible material, with a smooth inner surface design to reduce pressure on the user's foot skin. An outer surface of the contact piece 1 is provided with a plurality of first limit structures 2, and the first elastic band 3 is provided between adjacent two of second limit structures 2. The locking buckle 4 is provided on the first elastic band 3 to adjust the elasticity to adapt to different users'foot. The first housing 5 is connected to the sealing cover 6 through a plurality of fasteners 7, forming a water-resistant and dust-proof structure, which improves the durability and applicability of the device. The driving components include the vibration motor 8 located inside the first housing 5, the backup power supply 10, the controller 11 of the integrated inertial measurement unit, and the second signal transmission module. The vibration motor 8 is located directly above an instep, which can more directly transmit tactile feedback and enhance the user's immersion. The vibration motor 8 is electrically connected to the backup power supply 10, and the vibration block 9 is fixedly provided on an output shaft of the vibration motor 8. The shape of the vibration block 9 is an irregular geometry, with a polished surface and precise weight calculation to ensure the stability and accuracy of the vibration effect. The controller 11 of the integrated inertial measurement unit is electrically connected to the second signal transmission module. The first signal transmission module is electrically connected to the second signal transmission module. The controller 11 of the integrated inertial measurement unit is electrically connected to the control circuit. The controller 11 of the integrated inertial measurement unit is configured to detect the user's motion state and generate data. The second signal transmission module transmits data to the control circuit, and the control circuit triggers the vibration motor 8 based on physics engine data in the game, the vibration block 9 is caused to vibrate the contact piece 1. The vibration motor 8 is located directly above the instep to more directly transmit tactile feedback. The separate design of feedback part A and power supply part B ensures that feedback part A can still function normally when a main power supply is disconnected.

The power supply part B includes the battery module 12, the second limit structures 13, and the second elastic band 14. The battery module 12 includes the second housing, the battery pack, the first signal transmission module, and the control circuit. The battery pack, first signal transmission module, and control circuit are provided inside second housing. The first signal transmission module is electrically connected to the second signal transmission module for synchronizing game data. The power supply part B provides continuous power support to the feedback part A through an independent battery pack. A plurality of second limit structures 13 are provided on a surface of the second housing, and the second elastic band 14 is provided between adjacent two second limit structures 13 to fix the power supply part B to the user's thigh area. An inner side of the second elastic band 14 is provided with anti-slip patterns to prevent the device from sliding during use. An outer side of the second housing is provided with the operating component 15 and a plurality of indicator lights 16. The operating component 15 is connected to the control circuit through signal lines for starting the device or adjusting parameters. The indicator lights 16 include at least one low battery alarm light and one wireless connection state light. The indicator lights 16 are connected to the control circuit through a signal line for real-time display of device state. There are a plurality of ventilation holes 17 on two sides of the second housing, the ventilation holes 17 are used for heat dissipation. A bottom of the second housing is provided with an interface 18, and the interface 18 is configured for charging or data transmission.

A use method of the intelligent somatosensory foot-feedback device of the present disclosure is as follows.

Firstly, the power supply part B is placed on a thigh and fixed by the second limit structures 13 and the second elastic band 14 to ensure that the device is stable and will not shift due to movement. Then, the feedback part A is tied to a foot and fixed by the first elastic band 3 and the locking buckle 4. An inner surface of the contact piece 1 abuts against the user's foot skin to ensure that the vibration feedback can be accurately transmitted to the user's foot. Next, the device is started by the operating component 15, and a wireless connection is established with an external game system. The control circuit triggers the vibration motor 8 based on an expected movement trajectory and physics engine data in a game, the vibration block 9 is caused to drive the contact piece 1 to vibrate, thereby simulating sensory vibration feedback in the somatosensory football game. For example, in a motion sensing soccer game, when the user kicks the ball, the game system generates a corresponding trigger signal based on the physics engine data of the soccer ball. After the control circuit receives the signal, it triggers the vibration motor 8, and the vibration block 9 vibrates accordingly and transmits the vibration to the contact piece 1. The user's feet can feel the real feedback of kicking the ball. Besides that, the controller 11 of the integrated inertial measurement unit can monitor the user's foot movements in real time and provide feedback to the control circuit, further optimizing the accuracy and real-time performance of tactile feedback.

The intelligent somatosensory foot-feedback device of the present disclosure fully considers user experience and device practicality in its design. The contact piece 1 is made of flexible material with a smooth inner surface design to avoid irritation or discomfort to the user's foot skin. The design of the first elastic band 3 and the locking buckle 4 enables feedback part A to adapt to different sizes of users'foot and ensure the stability of the device during movement. The second elastic band 14 in the power supply part B is provided with anti-slip patterns on the inner side, further improving the anti-slip performance of the device. The ventilation holes 17 on two sides of the second housing help dissipate heat and prevent the device from overheating due to prolonged use. The interface 18 provided at the bottom can be used for charging or data transmission, rendering it convenient for the users to maintain and upgrade the device.

The vibration motor 8 in the feedback part A is located directly above the instep, and the selection of this position is based on a comprehensive consideration of the human foot structure and tactile sensitivity. The shape of the vibration block 9 is an irregular geometry, with a polished surface and precise weight calculation to ensure the stability and accuracy of the vibration effect. The vibration motor 8 is wirelessly connected to the control circuit, which can quickly respond to physics engine data in the game, thereby achieving real-time tactile feedback. Providing the backup power supply 10 provides additional power guarantee for the device, ensuring normal operation even when the main power supply is disconnected.

The operating component 15 and indicator light 16 in the power supply part B provide the users with an intuitive operating interface and device state display function. The operating component 15 can be used to start, turn off, or adjust parameters of the device through simple button operations, and the indicator lights 16 displays the device's battery state and wireless connection state in real time, rendering it convenient for the users to understand the device's operation state at any time. The capacity of the battery pack in the battery module 12 has been accurately calculated to meet the power requirements of the device under a high intensity use condition and considering the portability and lightweight design of the device.

In summary, the intelligent somatosensory foot-feedback device of the present disclosure achieves efficient and stable tactile feedback function through reasonable structural design and functional configuration, thereby enhancing user immersion and operational convenience. In order to better enable those skilled in the art to fully understand and implement the present disclosure, the specific implementation principle of the present disclosure will be supplemented with a specific application scenario.

Firstly, during a device wearing stage, the user needs to fix the power supply part B to the thigh area. By using the second limit structures 13 and the second elastic band 14 in combination, the power supply part B can firmly adhere to the user's leg, thereby avoiding device displacement caused by movement. The anti-slip patterns provided on the inner side of the second elastic band 14 further enhance the stability of the device, ensuring its reliability during high-intensity activities. Then, the feedback part A is fixed to the user's foot, and by adjusting the locking buckle 4 on the first elastic band 3, the contact piece 1 can tightly adhere to the user's foot skin and adapt to the size differences of different users'feet. The contact piece 1 is made of flexible materials and reduces skin irritation through a smooth inner surface, thereby enhancing wearing comfort.

Next, the user starts the device by the operating component 15 and establishes a wireless connection with the external gaming system. The indicator lights 16 displays the wireless connection state, indicating that the device has established communication with the gaming system. At this time, the battery pack in the battery module 12 provides power support to feedback part A through flexible wires, and the control circuit enters a standby state to receive physics engine data within the game. Flexible wires not only have signal transmission functions, but also, due to their flexibility and tensile resistance, can adapt to changes in users'limb movements during activities, ensuring stable transmission of signals and electricity.

When users participate in the motion sensing football game, the game system will generate a trigger signal based on the physics engine data of the collision between the football and the foot, and send the signal to the control circuit. When the user plays a virtual soccer ball in the game, the controller 11 of the integrated inertial measurement unit detects the real-time movement state of the foot and sends the data to the control circuit through the first signal transmission module and/or the second signal transmission module. The control circuit calculates the force and angle of the ball touch based on the received game physics engine data, and the vibration motor 8 is trigged. The vibration block 9 generates high-frequency vibration under the drive of the vibration motor 8. The irregular geometric shape and precisely calculated weight distribution of the vibration block 9 enable it to produce stable vibration effects. The vibration of the vibration block 9 is transmitted to the contact piece 1 through the first housing 5, and ultimately acts on the user's foot skin, simulating the real tactile feedback of kicking a ball. Due to the vibration motor 8 being located directly above the instep, this design considers both the structure of the human foot and tactile sensitivity, ensuring maximum effectiveness of vibration feedback, simulating real ball touch feedback, and enhancing user immersion.

Secondly, the controller 11 of the integrated inertial measurement unit monitors the user's foot movements in real time and feeds back the collected data to the control circuit. The control circuit combines the data provided by the controller 11 of the integrated inertial measurement unit and the in-game physics engine data to dynamically adjust the triggering strength and frequency of the vibration motor 8, thereby optimizing the accuracy and real-time performance of tactile feedback. For example, when the user kicks the ball with greater force, the game system will generate a stronger trigger signal, and the control circuit will correspondingly increase the working intensity of the vibration motor 8, rendering the user feel stronger tactile feedback. On the contrary, when the kicking force is low, the intensity of tactile feedback will also decrease accordingly. This dynamic adjustment mechanism based on physics engine data and user actions makes tactile feedback more realistic.

Furthermore, the separation design of feedback part A and power supply part B significantly improves the comfort and reliability of the device during long-term use. The waterproof and dustproof structure of the sealing cover 6 enables the feedback part A to operate stably in various environments and adapt to different usage needs. The indicator lights 16 displays the device state in real-time, for example, the low battery alarm light will light up when the battery is low, reminding the users to charge in a timely manner. The wireless connection state light is used to indicate whether the device has successfully established a connection with the external gaming system, ensuring that users can keep track of the device's operation state at any time. The ventilation holes 17 effectively dissipate heat, avoiding performance degradation caused by overheating. The battery pack in the power supply part B provides continuous power support to feedback part A through the interface 18, and the interface 18 can be used for charging or data transmission, rendering it convenient for users to maintain and upgrade the equipment.

In summary, the present disclosure achieves a complete process from device wearing to tactile feedback generation through reasonable structural design and functional configuration. The collaborative work between the power supply part B and the feedback part A, as well as the fast response of the vibration motor 8 based on physical engine data, together constitutes an efficient and stable tactile feedback system. This system not only enhances users'immersion in motion sensing games but also brings high-quality operating experience to users through convenient wearing design and reliable performance.

In the description of the present disclosure, it should be noted that terms “center”, “up”, “down”, “left”, “right”, “vertical”, “horizontal”, “inside”, “outside”, etc. indicate orientation or positional relationships based on the orientation or positional relationships shown in the accompanying drawings, only for the convenience of describing this disclosure and simplifying the description, and do not indicate or imply that the device or element referred to must have a specific orientation, be constructed and operated in a specific orientation, and therefore cannot be understood as a limitation of the present disclosure. Besides that, terms “first”, “second”, and “third” are only used for descriptive purposes and cannot be understood as indicating or implying relative importance.

In the present disclosure, it should be noted that unless otherwise specified and limited, the terms “installation”, “connection to”, and “connection with” should be broadly understood, for example, it can be a fixed connection, a detachable connection, or an integral connection; it can be a mechanical connection or an electrical connection; it can be directly connected, indirectly connected through an intermediate medium, or connected internally between two components. For those skilled in the art, specific meanings of the above terms in the present disclosure can be understood in specific situations.

Obviously, technicians in this field can make various modifications and variations to this application without departing from its spirit and scope. In this way, if these modifications and variations of the present application fall within the scope of the claims and equivalent technologies of the present application, then the present application also intends to include these modifications and variations.

What is claimed is:

1. An intelligent somatosensory foot-feedback device, comprising a feedback part and a power supply part, wherein the feedback part and the power supply part are electrically connected to achieve signal transmission and energy supply;
the feedback part is configured to be worn on a user's foot, and comprises a fitting component and a driving component;
the power supply part is configured to be fixed on a thigh, and comprises a battery module, second limit structures, and a second elastic band; the battery module comprises a second housing, a battery pack, a first signal transmission module, and a control circuit; the battery pack, the first signal transmission module, and the control circuit are provided inside the second housing,
the first signal transmission module and the control circuit are electrically connected;
a surface of the second housing is provided with a plurality of second limit structures, and the second elastic band is provided between two of the plurality of second limit structures.

2. The intelligent somatosensory foot-feedback device according to claim 1, wherein the fitting component comprises a contact piece, an outer surface of the contact piece is provided with a plurality of first limit structures, and a first elastic band is provided between two of the plurality of first limit structures,
a locking buckle is provided on the first elastic band;
the driving component comprises a first housing provided on an outer surface of the contact piece, wherein the first housing is provided with a sealing cover through a plurality of fasteners to form a water-resistant and dust-proof structure;
the driving component further comprises a vibration motor provided inside the first housing, and the vibration motor is electrically connected to the control circuit;
a vibration block is fixedly provided on an output shaft of the vibration motor;
the first housing further comprises a backup power supply, a controller of an integrated inertial measurement unit, and a second signal transmission module;
the vibration motor is electrically connected to the backup power supply, the controller of the integrated inertial measurement unit is electrically connected to the second signal transmission module,
the first signal transmission module is electrically connected to the second signal transmission module,
the controller of the integrated inertial measurement unit is electrically connected to the control circuit so as to trigger the vibration motor based on physics engine data in a game, and the battery pack is electrically connected to the backup power source.

3. The intelligent somatosensory foot-feedback device according to claim 1, wherein an operating component is provided on an outer side of the second housing, and the operating component is electrically connected to the control circuit;
the outer side of the second housing is further provided with a plurality of indicator lights, and the indicator lights are electrically connected to the control circuit.

4. The intelligent somatosensory foot-feedback device according to claim 3, wherein the indicator lights comprise at least one low battery alarm light and one wireless connection state light.

5. The intelligent somatosensory foot-feedback device according to claim 1, wherein the contact piece is made of soft material and has a smooth inner surface;
the first elastic band and the locking buckle are configured to adjust an elasticity of the contact piece to adapt to different users'foot.

6. The intelligent somatosensory foot-feedback device according to claim 1, wherein an inner side of the second elastic band is provided with anti-slip patterns.

7. The intelligent somatosensory foot-feedback device according to claim 2, wherein the vibration motor is located directly above an instep, and is configured to generate tactile feedback in response to physical engine data.

8. The intelligent somatosensory foot-feedback device according to claim 2, wherein a plurality of ventilation holes are provided on two sides of the second housing, and an interface is provided at a bottom of the second housing, the interface is configured for charging or data transmission.

9. The intelligent somatosensory foot-feedback device according to claim 2, wherein the vibration block is an irregular geometric shape, a surface of the vibration block is polished, and a weight of the vibration block is accurately calculated.

10. A use method of the intelligent somatosensory foot-feedback device according to claim 1, comprises the following steps:
S1: providing the power supply part on a thigh and fixing the power supply part with the second elastic band and second limit structures;
S2: providing the feedback part to a foot, fixing the feedback part with a first elastic band and a locking buckle, and an inner surface of contact piece abutting against a user's foot skin;
S3: starting a device by an operating component, and establishing a wireless connection with an external gaming system;
S4: triggering a vibration motor based on an expected movement trajectory and physics engine data in a game, by the control circuit, causing the vibration motor to rotate and drive the vibration block to vibrate, and causing a contact piece to vibrate.
